(19) United States
(12) Patent Application Publication
(10) Pub. No.: US 2006/0140303 A1
(43) Pub. Date: Jun. 29, 2006

(54) Wireless communication method and apparatus

(76) Inventors: Yoshimasa Egashira, Kawasaki-shi (JP); Daisuke Takeda, Kawasaki-shi (JP); Tsuguhide Aoki, Kawasaki-shi (JP); Yasuhiko Tanabe, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/200,297

(22) Filed: Aug. 10, 2005

(30) Foreign Application Priority Data
Dec. 24, 2004 (JP) 2004-374956

(51) Int. Cl. H04B 7/06; H04K 1/10; H04L 1/02

(52) U.S. Cl. 375/299; 375/260; 375/347

(57) ABSTRACT

In transmitting a wireless packet signal for channel response estimation, after AGC preambles and channel estimation preambles are transmitted by using a plurality of antennas, at least one data stream is transmitted, as subcarriers distributed to the plurality of antennas, by using the plurality of antennas.

### CROSS-REFERENCE TO RELATED APPLICATIONS

This application is based upon and claims the benefit of priority from prior Japanese Patent Application No. 2004-374956, filed Dec. 24, 2004, the entire contents of which are incorporated herein by reference.

### BACKGROUND OF THE INVENTION

1. Field of the Invention

The present invention relates to a MIMO-OFDM communication system which communicates by using a plurality of antennas and a plurality of subcarriers and, more particularly, to a wireless communication method and apparatus suitable for a high-speed wireless LAN.

2. Description of the Related Art

The United States Institute of Electrical and Electronics Engineers (IEEE) is now defining a wireless LAN standard called IEEE 802.11n, which aims to achieve a high throughput of 100 Mbps or more. It is very possible that IEEE 802.11n will employ a technique called multi-input multi-output (MIMO), which uses a plurality of antennas for a transmitter and a receiver. IEEE 802.11n is required to coexist with the IEEE 802.11a standard, which has already been standardized, in a wireless communication unit. According to the MIMO technique, in order to measure channel responses from a plurality of transmission antennas to the respective reception antennas, preambles which are known sequences must be transmitted from the respective transmission antennas.

According to the proposal for preamble signals which has been proposed by Jan Boer et al., “Backwards Compatibility”, IEEE 802.11-03/714r0, a short preamble sequence used for timing synchronization, frequency synchronization, and automatic gain control (AGC), a long preamble sequence for channel response estimation, and a first signal field including a field indicating a modulation scheme for the wireless packet or its length are transmitted first from a single specific transmission antenna. A second signal field used in IEEE 802.11n is then transmitted. Subsequently, long preamble sequences for channel response estimation are sequentially transmitted from a plurality of transmission antennas. After the transmission of the preamble signals is complete in this manner, transmission data are simultaneously transmitted from a plurality of transmission antennas.

On the other hand, according to the proposal for the frame arrangement of a wireless communication packet for IEEE 802.11n which has been proposed by Syed Aon Mujtaba et al., “TGn Sync Proposal Technical Specification”, first of all, a short preamble (legacy short training field) used for timing synchronization, frequency synchronization, and AGC, a long preamble (legacy long training field) for channel response estimation, a first signal field (legacy signal field) including a field indicating a modulation scheme for the wireless packet or its length, and a second signal field (high-throughput signal field) used in IEEE 802.11n are transmitted from a single specific transmission antenna. Subsequently, a second short preamble (high-throughput short training field) for AGC in MIMO communication, and a second long preamble (high-throughput long training field) for channel response estimation are sequentially transmitted from a plurality of transmission antennas at once. After the transmission of the preamble signals is complete in this manner, different data stream signals are simultaneously transmitted from a plurality of antennas using data fields. The second short preamble and the second long preamble are transmitted from the same antenna as that used for the transmission of data fields.

Generally, in wireless receiving devices, a received signal is demodulated by digital signal processing. Therefore, an analog-to-digital converter which converts a received signal obtained as an analog signal into a digital signal is prepared. The analog-to-digital converter has an allowable level range of analog signals to be converted (to be referred to as an input dynamic range hereinafter). Accordingly, it is necessary to perform AGC for adjusting the levels of received signals within the input dynamic range of the analog-to-digital converter.

Since channel response using a long preamble is estimated by digital signal processing, AGC must be performed by using the signal transmitted before the long preamble. According to the preamble signal proposed by Jan Boer et al., “Backwards Compatibility”, IEEE 802.11-03/714r0, therefore, AGC is performed by using a short preamble transmitted from a specific transmission antenna before the long preamble. That is, the reception level of the short preamble is measured, and AGC is performed so that the signal level falls within the input dynamic range of the analog-to-digital converter. This makes it possible to receive the long preambles and signal fields transmitted from the specific transmission antenna. However, since no preambles are transmitted from other transmission antennas before long preambles, only the short preamble transmitted from one transmission antenna can be used for AGC.

If all the transmission antennas are spaced apart from each other, the reception levels of signals transmitted from the transmission antennas are inevitably different from each other. Therefore, when the reception side receives long preambles transmitted from other transmission antennas or data signals simultaneously transmitted from all the antennas, their reception levels may be much higher or lower than the level adjusted by AGC using the short preamble transmitted from the specific transmission antenna. When the reception level exceeds the upper limit of the input dynamic range of the analog-to-digital converter, the analog-to-digital converter is saturated. When the reception level is lower than the lower limit of the input dynamic range of the analog-to-digital converter, a large quantization error occurs in the analog-to-digital converter. In either case, the analog-to-digital converter cannot perform appropriate conversion, which adversely influences the processing after analog-to-digital conversion.

According to Syed Aon Mujtaba et al., “TGn Sync Proposal Technical Specification”, AGC is performed by using the second short preambles simultaneously transmitted from a plurality of antennas. Even when, therefore, data are simultaneously transmitted from the respective antennas, the received signal levels of the second long preambles and data fields are adjusted to fall within the input dynamic range of the analog-to-digital converter, thereby allowing these signals to be properly received.

The MIMO techniques are roughly classified into a scheme which does not use channel responses on the transmission side and a scheme which uses channel responses. The latter scheme can obtain a high communication capacity. On the other hand, on the transmission side, it is necessary to estimate many propagation path responses (to be referred to as channel responses) between all the antennas on the transmission side and all the antennas on the reception side. In order to estimate channel responses on the transmission side, the following method may be used. First of all, the transmission side transmits a request signal to the reception side. Upon receiving the request signal, the reception side transmits a wireless packet signal containing a preamble signal for channel response estimation to the transmission side. The transmission side estimates a channel response by using the channel estimation preamble signal in the received wireless packet signal.

In this case, the transmission side needs to estimate the channel responses of propagation paths between the respective antennas on the reception side and all the antennas on the transmission side by using received channel estimation preamble signals. For this reason, channel estimation preambles must be transmitted from all the antennas on the reception side regardless of the number of data field streams.

In a wireless packet disclosed in Jan Boer et al., “Backwards Compatibility”, IEEE 802.11-03/714r0, a long preamble for channel response estimation is transmitted from only an antenna which transmits a data field. In other words, when the number of data field streams is smaller than the number of antennas, no channel estimation preamble is transmitted from any antenna which transmits no data field. Therefore, the wireless packet in Syed Aon Mujtaba et al., “TGn Sync Proposal Technical Specification” cannot be used as a wireless packet signal for channel response estimation.

### BRIEF SUMMARY OF THE INVENTION

It is an object of the present invention to provide a wireless communication method and apparatus which can estimate on the reception side channel responses between all transmission antennas and all reception antennas while suppressing quantization errors in data fields and saturation after analog-to-digital conversion.

In accordance with a first aspect of the invention, there is provided a wireless communication method comprising: transmitting automatic gain control (AGC) preambles by using a plurality of antennas; transmitting channel estimation preambles after transmission of the AGC preambles by using the plurality of antennas; and transmitting at least one data stream as subcarriers distributed to the plurality of antennas after transmission of the AGC preambles by using the plurality of antennas.

In accordance with a second aspect of the invention, there is provided a wireless communication device comprising: a plurality of antennas; and a generating unit configured to generate a wireless packet signal comprising an automatic gain control (AGC) preamble to be transmitted by using the plurality of antennas, a channel estimation preamble to be transmitted after transmission of the AGC preamble by using the plurality of antennas, and at least one data stream to be transmitted by the plurality of antennas, as subcarriers distributed to the plurality of antennas after transmission of the channel estimation preamble.

In accordance with a third aspect of the invention, there is provided a wireless communication device comprising: a receiver which generates a reception signal by receiving a plurality of automatic gain control (AGC) preambles to be transmitted from a plurality of antennas, a channel estimation preamble to be transmitted after transmission of the AGC preambles from the plurality of antennas, and at least one data stream to be transmitted by the plurality of antennas, as subcarriers distributed to the plurality of antennas after transmission of the channel estimation preamble; a variable gain amplifier which amplifies the reception signal; a gain control unit configured to controls a gain of the variable gain amplifier by using information of the AGC preamble contained in the reception signal; and an analog-to-digital converter which converts an output signal from the variable gain amplifier into a digital signal.

In accordance with a fourth aspect of the invention, there is provided a wireless communication method comprising: transmitting a request signal to a second wireless communication device with a first wireless communication device; transmitting a wireless packet signal in response to the request signal with the second wireless communication device via a plurality of antennas, the wireless packet signal comprising an automatic gain control (AGC) preamble, a channel estimation preamble, and at least one data stream as subcarriers distributed to the plurality of antennas; and estimating a channel response by receiving the wireless packet signal with the first wireless communication device.

### BRIEF DESCRIPTION OF THE SEVERAL VIEWS OF THE DRAWING

FIG. 1 is a block diagram showing the schematic arrangement of a wireless communication system according to the first embodiment;

FIG. 2 is a block diagram showing the main part of a second wireless communication device according to the first embodiment;

FIGS. 3A, 3B, 3C and 3D are views for explaining a wireless packet signal for channel response estimation according to the first embodiment;

FIG. 4 is a block diagram showing the main part of the first wireless communication device according to the first embodiment; and

FIG. 5 is a block diagram showing a receiver in the first wireless communication device shown in FIG. 4 which is associated with a wireless packet signal for channel response estimation.

### DETAILED DESCRIPTION OF THE INVENTION

### FIRST EMBODIMENT

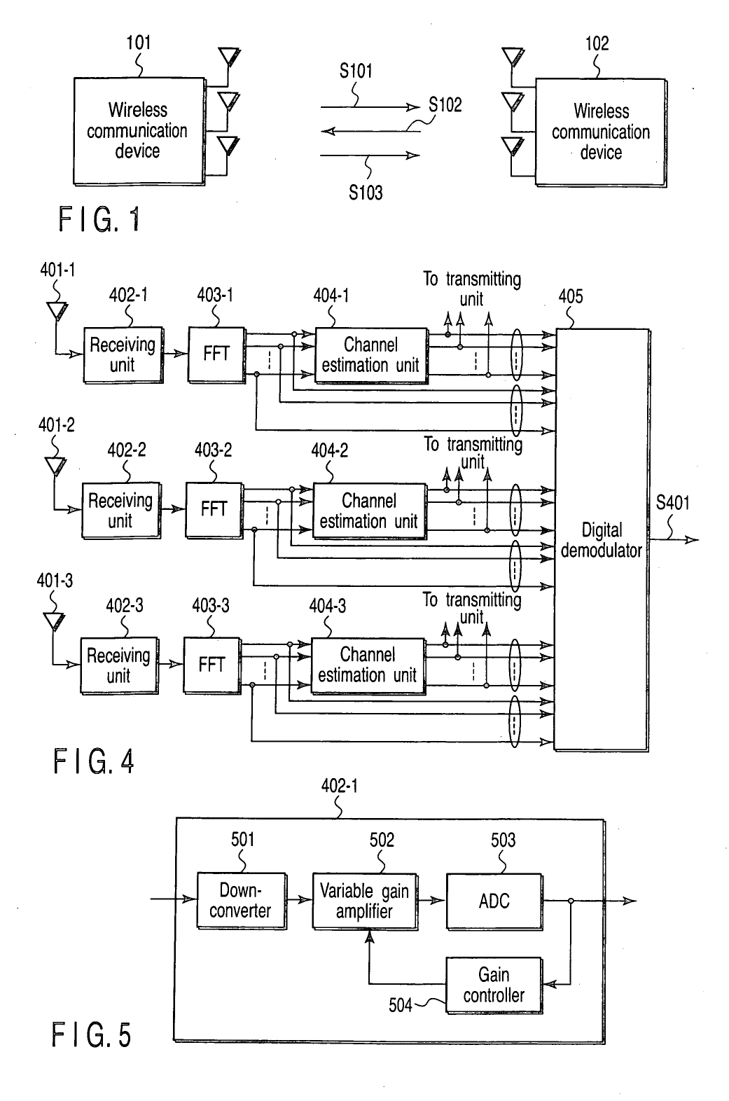

FIG. 1 shows a wireless communication system using MIMO according to the first embodiment of the present invention, in which two wireless communication devices 101 and 102 both have a plurality of antennas. When the wireless communication device 101 is to use weighted space division multiplexing (W-SDM), eigenbeam space division multiplexing (E-SDM), or an adaptive modulation scheme or the like, communication between the wireless communication device 101 and the wireless communication device 102 is performed in accordance with the following sequence.

First of all, the wireless communication device 101 transmits, to the wireless communication device 102, a request signal S101 to request the transmission of a wireless packet signal (to be also referred to as a “sounding packet”) for channel response estimation. Upon receiving the request signal S101, the wireless communication device 102 transmits a wireless packet signal S102 as a sounding packet to the wireless communication device 101. The wireless communication device 101 estimates channel responses between all the antennas of the wireless communication device 101 and all the antennas of the wireless communication device 102 on the basis of the received wireless packet signal S102. The wireless communication device 101 transmits a signal S103 to the wireless communication device 102 by using W-SDM, E-SDM, or the adaptive modulation scheme on the basis of the estimated channel responses.

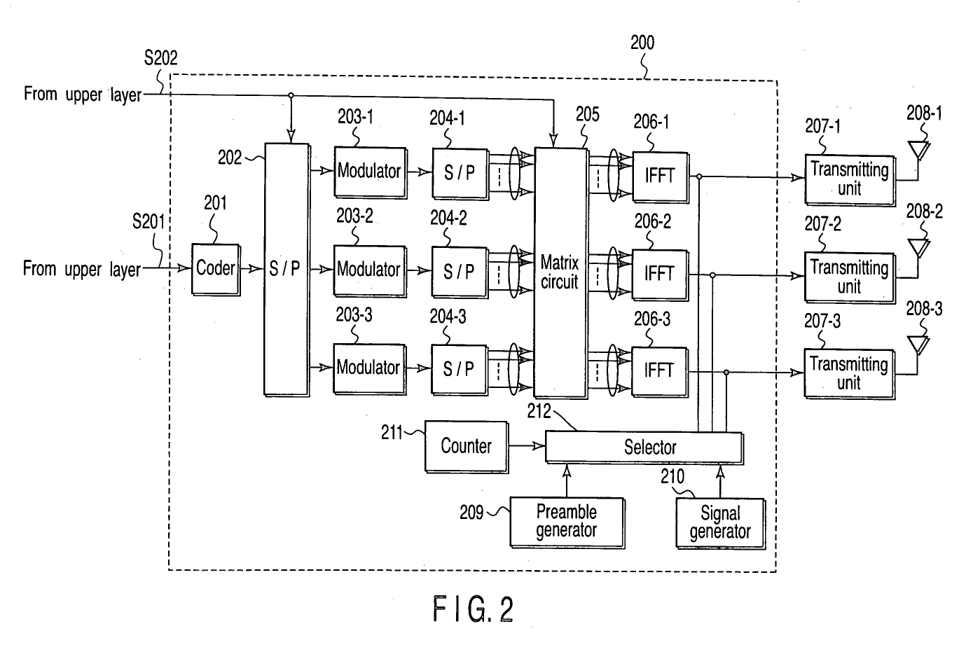

A specific example of the wireless communication device 102 in FIG. 1 will be described next with reference to FIG. 2. FIG. 2 shows the physical layer of a wireless packet signal transmitter 200, of the wireless communication device 102, which is used for channel response estimation, in particular. The wireless packet signal transmitter 200 may be formed on, for example, one integrated circuit chip.

When the request signal S101 from the wireless communication device 101 is received by a receiver (not shown) in the wireless communication device 102, transmission data (bit string) S201 is input from the upper layer to the wireless packet signal transmitter 200 for each transmission unit. The transmission data S201 contains upper layer control data (e.g., the address information of the wireless communication device 101 and wireless communication device 102), information data, and the like.

A coder 201 performs, for example, error correction coding for the transmission data S201 to generate a coded data sequence. A serial-to-parallel converter 202 performs serial-to-parallel conversion for the coded data sequence in accordance with the number of streams designated by using a signal S202 from the upper layer to divide the coded data sequence into a plurality of data streams. The wireless communication device shown in FIG. 2 can divide a coded bit sequence into a maximum of three data streams. The number of streams need not always be designated from the upper layer, and may be determined by the physical layer of the wireless packet signal transmitter 200 by itself. For example, in general, the communication speed increases as the number of streams increases. On the other hand, this leads to deterioration in communication quality. The number of streams is therefore determined in consideration of both communication speed and communication quality. More specifically, for example, the number of streams is increased with an increase in the data length of a coded data sequence.

Modulators 203-1 to 203-3 map the data streams from the serial-to-parallel converter 202 on complex planes (I-Q) to generate modulated data symbols. The modulated data symbols are serial-to-parallel-converted by serial-to-parallel converters 204-1 to 204-3 to be transmitted on the subcarriers of orthogonal frequency-division multiplexing (OFDM) signals, respectively.

The serial-to-parallel-converted data symbols are input to a matrix circuit 205. The matrix circuit 205 distributes the input subcarriers to the respective antennas in accordance with the stream count information S202 transmitted from the upper layer. A more specific subcarrier distribution method will be described in detail later. The subcarriers distributed to the respective antennas are converted from signals on the frequency domain into signals on the time domain by inverse fast Fourier transform (IFFT) units 206-1 to 206-3. The signals on the time domain are input to transmitting units 207-1 to 207-3. The transmitting units 207-1 to 207-3 are generally formed on an integrated circuit chip different from that of the wireless packet signal transmitter 200. The transmitting units 207-1 to 207-3 may be formed on the same chip as the integrated circuit chip of the wireless packet signal transmitter 200. In addition, antennas 208-1 to 208-3 may be formed on the same chip.

In the transmitting units 207-1 to 207-3, output signals from the IFFT units 206-1 to 206-3 are converted first into analog signals by digital/analog converters (not shown). The output signals from the digital/analog converts are in the baseband or intermediate-frequency (IF) band, and are converted into signals in the radio frequency (RF) band by frequency converters (up-converters) (not shown). The output signals from the frequency converters are supplied to the antennas 208-1 to 208-3 through power amplifiers. As a consequence, OFDM signals are transmitted from the antennas 208-1 to 208-3 to the wireless communication device 101 as a communication partner.

In this manner, before the data symbols of wireless packet signals for channel response estimation are transmitted as OFDM signals, a preamble signal sequence and signal field signal sequence are transmitted. A method of generating preamble data and signal data in a wireless packet signal for channel response estimation will be described below.

A preamble generator 209 is, for example, a read-only memory (ROM), in which the time domain information of a plurality of preamble signals known on the reception side are stored. A signal generator 210 generates an OFDM signal containing information such as a packet length, a data modulation scheme, and the number of streams, which is required when the wireless communication device 101 demodulates a wireless packet signal for channel response estimation. When preambles and signal fields are to be transmitted, the time domain information of a plurality of preambles stored in the ROM of the preamble generator 209 or the time domain information of signal fields generated by the signal generator 210 are sequentially read out at timings when they should be transmitted in accordance with signals from a counter 211, and are provided to the transmitting units 207-1 to 207-3 through a selector 212.

The selector 212 reads out time domain information from the preamble generator 209 and signal generator 210 in accordance with the transmission timings of a plurality of preambles and signal fields which are continuously transmitted, and distributes them to transmit them from proper antennas. The selector 212 distributes preambles and signal fields to the antennas 208-1 to 208-3 in accordance with a count value indicating time information from the counter 211.

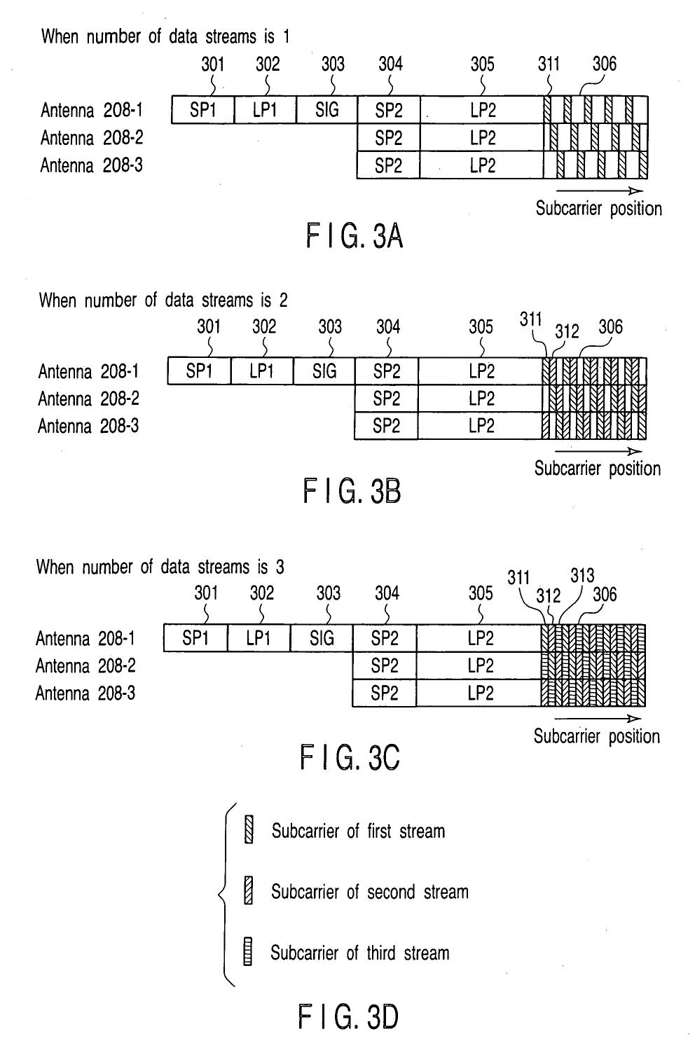

The frame structures of wireless packet signals for channel response estimation which are transmitted from the antennas 208-1 to 208-3 will be described next with reference to FIGS. 3A to 3D. FIGS. 3A, 3B, and 3C respectively show the frame structures on the time domain for cases wherein the number of data streams is “1”, “2”, and “3”. With regard to a data field 306, subcarriers to which data streams are assigned are indicated by different hatchings for each stream, as shown in FIG. 3D. Each of the wireless packet signals shown in FIGS. 3A, 3B, and 3C as signals transmitted from the single antenna 208-1 has a first short preamble (SP1) 301 (which complies with an existing standard (e.g., IEEE 802.11a standard) and is also called a “legacy short training field”), a first long preamble (LP1) 302 (to be also referred to as a “legacy long training field”), and a signal field (SIG) 303. Note that guard intervals may appropriately be added before a long preamble, signal field, and data field to increase robustness against multipath.

In the wireless communication device 101 which receives a wireless packet (sounding packet) signal for channel response estimation, the first short preamble 301 is used for frame head detection, timing synchronization, and AGC. In the wireless communication device 101, the first long preamble 302 is used to estimate a channel response from the antenna 208-1 to each antenna of the wireless communication device 101. The estimated channel response is mainly used for the demodulation of the signal field 303. The signal field 303 contains information necessary for the demodulation of the data field 306 to be transmitted on the subsequent stage, e.g., a wireless packet length, a data field modulation scheme, the number of streams, and information indicating that the wireless packet signal is a wireless packet signal for channel response estimation.

After the signal containing the first short preamble 301, first long preamble 302, and signal field 303 is transmitted from one antenna 208-1, a signal containing a second short preamble (SP2) 304 (which is also called a “high-throughput short training field” to indicate that the signal complies with a standard that allows an increase in transmission speed, e.g., IEEE 802.11n, with respect to existing standards), a second long preamble (LP2) 305 (which is also called a “high-throughput long training field” for the same reason), and the data field 306 is transmitted from all the antennas 208-1 to 208-3. The second short preamble 304 is used for AGC for the second long preamble 305 and data field 306. The second long preambles 305 are used in the wireless communication device 101 to estimate channel responses between all the antennas of the wireless communication device 101 and all the antennas of the wireless communication device 102. The channel responses estimated by the second long preambles 305 are used not only for the demodulation of the data field 306 but also for E-SDM, W-SDM, adaptive modulation, or the like in which the wireless communication device 101 requires channel responses. Note that the signal field 303 contains the first signal field (which is also called a “legacy signal field”) complying with an existing standard (e.g., IEEE 802.11a standard) and the second signal field (which is also called a “high-throughput signal field”) complying with a standard suitable for high transmission speed, e.g., IEEE 802.11n. The first signal field portion may be output from only the antenna 208-1.

In the data field 306, at least one data stream is transmitted from a plurality of antennas as subcarriers distributed to a plurality of antennas. For example, in this embodiment, as shown in FIGS. 3A, 3B, and 3C, the subcarriers for three data streams are equally distributed to all the antennas 208-1 to 208-3. In other words, the subcarriers for each data stream are interleaved between the antennas. That is, in each of the cases shown in FIGS. 3A, 3B, and 3C, subcarriers 311 for the first stream of the three data streams, subcarriers 312 for the second stream, and subcarriers 313 for the third stream are shifted from each other one subcarrier at a time in the array direction (frequency direction) of the subcarriers. This arrangement can be generalized by a mathematical expression as follows.

Letting M be the number of antennas, N be the number of subcarriers for an OFDM signal, and I be the number of data streams, an antenna number m(n, i, M) to which the n (=1, 2, . . . , N)th subcarrier in the i (=1, 2, . . . , I)th data stream input to the matrix circuit 205 in FIG. 2 is assigned is given by
m(n,i,M)={(n−i+M) mod M}+1 (1)
where “A mod B” is an operator for calculating the remainder of A divided by B.

If the number of data streams is equal to the number of antennas, as in the case shown in FIG. 3C, it is not always necessary to distribute the subcarriers for the data streams to the respective antennas as shown in FIG. 3C. Data streams may be made to correspond to antennas, and the respective data streams may be transmitted from corresponding antennas. That is, only when the number of data streams is smaller than the number of antennas, the data streams may be transmitted as subcarriers distributed to a plurality of antennas, as shown in FIGS. 3A and 3B. The packet formats shown in FIGS. 3A, 3B, and 3C are temporally expressed. For the sake of descriptive convenience, however, with regard to the data field portions, the subcarriers to which the streams are assigned are expressed by different patterns for each stream.

A specific example of the wireless communication device 101 in FIG. 1 will be described with reference to FIG. 4. FIG. 4 shows the physical layer of the wireless communication device 101, more specifically, the receiver which receives wireless packet signals for channel response estimation shown in FIGS. 3A, 3B, and 3C. In the wireless communication device 101, a plurality of antennas 401-1 to 401-3 receive wireless packet signals for channel response estimation shown in FIGS. 3A, 3B, and 3C which are transmitted from the wireless communication device 102. The RF reception signals output from the antennas 401-1 to 401-3 are input to receiving units 402-1 to 402-3. The receiving units 402-1 to 402-3 perform frequency conversion (down-conversion) to convert the reception signals in the RF band to signals in the baseband, and perform AGC and analog-to-digital conversion, thereby generating baseband signals.

The baseband signals from the receiving units 402-1 to 402-3 are input to fast Fourier transform (FFT) units 403-1 to 403-3 to be converted from the signals in the time domain into signals in a frequency domain, i.e., signals for the respective subcarriers. The resultant signals are input to channel estimation units 404-1 to 404-3 and digital demodulator 405. The channel estimation units 404-1 to 404-3 estimate channel responses from the wireless communication device 102 to the wireless communication device 101. The digital demodulator 405 demodulates the baseband signals in accordance with the channel responses estimated by the channel estimation units 404-1 to 404-3 to generate reception data S401 corresponding to the transmission data S201 shown in FIG. 2.

FIG. 5 shows the detailed arrangement of the receiving unit 402-1. Since receiving unit 402-1 is identical to the remaining receiving units 402-2 and 402-3, only the receiving unit 402-1 will be described below. An RF reception signal as a wireless packet signal for channel response estimation which is output from the reception antenna 401-1 is down-converted by a down-converter 501 to generate a baseband signal. The baseband signal from the down-converter 501 is input to a variable gain amplifier 502 to be subjected to AGC, i.e., signal level adjustment. The output signal from the variable gain amplifier 502 is converted into a digital signal by an analog-to-digital converter 503. The digital signal output from the analog-to-digital converter 503 is output out of the receiving unit 402-1, and is also input to a gain controller 504. The gain controller 504 calculates a gain from the digital signal from the analog-to-digital converter 503, and controls the gain of the variable gain amplifier 502 on the basis of the calculated gain. This AGC will be described in detail later.

A specific example of operation to be performed when the wireless communication device 101 receives a wireless packet signal for channel response estimation shown in FIGS. 3A to 3C will be described with reference to FIGS. 4 and 5.

First of all, the wireless communication device 101 receives the first short preamble 301 transmitted from the antenna 208-1, detects frame head by using a baseband signal corresponding to the first short preamble 301, and performs timing synchronization, automatic frequency control (AFC), and AGC. AFC is also called frequency synchronization. Since known techniques can be used for frame head detection, timing synchronization, and AFC, a description thereof will be omitted. AGC, in particular, will be described below.

A baseband signal corresponding to the first short preamble 301 is amplified by the variable gain amplifier 502 in accordance with a preset initial gain value. The output signal from the variable gain amplifier 502 is input to the gain controller 504 through the analog-to-digital converter 503. The gain controller 504 calculates a gain from the level of the reception signal corresponding to the short preamble 301 after analog-to-digital conversion, and controls the gain of the variable gain amplifier 502 in accordance with the calculated gain.

Let X be the level of a baseband signal corresponding to the short preamble 301 before analog-to-digital conversion. If the level X is high, the baseband signal exceeds the upper limit of the input dynamic range of the analog-to-digital converter 503. As a result, the digital signal obtained by analog-to-digital conversion is saturated. For this reason, a signal at a high level, in particular, is distorted. If the level X is low, the signal with the low level, in particular, contains a large quantization error upon analog-to-digital conversion. In either the case wherein the level X before analog-to-digital conversion is high or the case wherein the level X is low, the analog-to-digital converter 503 does not perform proper conversion, resulting in a serious trouble in terms of reception quality.

In order to solve this problem, the gain controller 504 controls the gain of the variable gain amplifier 502 such that the level X of the baseband signal corresponding to the short preamble 301 before analog-to-digital conversion becomes a target value Z. In some cases, when the level of a baseband signal is so high as to saturate all signals input to the analog-to-digital converter 503 or excessively low, the gain of the variable gain amplifier 502 cannot be properly controlled by one control operation. In such a case, gain is repeatedly controlled. As a consequence, the level of the baseband signal input to the analog-to-digital converter 503 can be adjusted to a proper level so as to fall within the input dynamic range of the analog-to-digital converter 503. By controlling the gain of the variable gain amplifier 502 using a baseband signal corresponding to the short preamble 301 in this manner, proper analog-to-digital conversion can be done, and a deterioration in reception quality can be avoided.

Subsequently, the wireless communication device 101 receives the first long preamble 302 transmitted from the antenna 208-1, and estimates channel response by using a signal in a frequency domain corresponding to the first long preamble 302. That is, the wireless communication device 101 estimates channel responses from the wireless communication device 102 to the wireless communication device 101 by using the channel estimation units 404-1 to 404-3.

More specifically, since the long preamble 302 is transmitted from only the antenna 208-1, the channel estimation unit 404-1 estimates a channel response from the antenna 208-1 to the antenna 401-1. Likewise, the channel estimation unit 404-2 estimates a channel response from the antenna 208-1 to the antenna 401-2, and the channel estimation unit 404-3 estimates a channel response from the antenna 208-1 to the antenna 401-3. Since a known technique can be used for this channel estimation, a detailed description thereof will be omitted.

If the signal transmitted from the antenna 208-1 has undergone AGC as described above, the level of an input to the analog-to-digital converter 503 will have been properly adjusted before channel response estimation. With regard to a signal transmitted from the transmission antenna 208-1, a high-precision digital signal can be obtained from the analog-to-digital converter 503, and hence a channel response can be accurately estimated by using the digital signal.

Subsequently, the wireless communication device 101 receives the signal field 303 transmitted from the transmission antenna 208-1, and causes the digital demodulator 405 to perform demodulation processing for a signal in the frequency domain corresponding to the signal field 303 by using the above channel response estimation result. Information such as a wireless packet length, a modulation scheme for succeeding data, and the number of streams is described in the signal field 303. The wireless communication device 101 continuously performs demodulation processing by using the digital demodulator 405 in a wireless packet interval recognized from the wireless packet length information in the signal field 303.

The wireless communication device 101 receives the second short preambles 304 transmitted from the transmission antennas 208-1 to 208-3. The second short preambles 304 are transmitted from the transmission antenna 208-1, which has continued transmission up to the signal field 303, and transmission antennas 208-2 and 208-3, which have not performed transmission. As compared with the case wherein the signal (the first short preamble 301, first long preamble 302, and signal field 303) transmitted from only the transmission antenna 208-1 is received, the reception level changes in the case wherein the second short preambles 304 are received.

Upon receiving the second short preambles 304, the wireless communication device 101 performs AGC again by using the second short preambles 304. That is, the wireless communication device 101 controls the gains of the variable gain amplifiers 502 again by using the levels of baseband signals corresponding to the second short preambles 304 after analog-to-digital conversion. With this operation, the reception levels of signals simultaneously transmitted from the transmission antennas 208-1 to 208-3 are properly adjusted, and the resultant signals are input to the analog-to-digital converters 503. That is, the second long preambles 305 and data fields 306 simultaneously transmitted from the transmission antennas 208-1 to 208-3, like the second short preambles 304, are input to the analog-to-digital converters 503 after the reception levels are properly adjusted. When, therefore, the second long preambles 305 and data fields 306 are received as well, the input levels of the signals to the analog-to-digital converters 503 are properly adjusted. This makes it possible to reduce the influences of the saturation of outputs from the analog-to-digital converters 503 and quantization errors, thereby improving the reception precision.

Subsequently, the wireless communication device 101 receives the second long preambles 305 transmitted following the second short preambles 304 from the transmission antennas 208-1 to 208-3, and estimates channel response by using signals in frequency domains corresponding to the second long preambles 305. That is, the wireless communication device 101 estimates channel responses from the wireless communication device 102 to the wireless communication device 101 by using the channel estimation units 404-1 to 404-3. More specifically, since the long preambles 305 are transmitted from all the antennas 208-1 to 208-3 of the wireless communication device 102, the channel estimation unit 404-1 estimates channel responses from the antennas 208-1 to 208-3 to the antenna 401-1. Likewise, the channel estimation unit 404-2 estimates channel responses from the antennas 208-1 to 208-3 to the reception antenna 401-2. The channel estimation unit 404-3 estimates channel responses from the antennas 208-1 to 208-3 to the antenna 401-3. In this manner, by using the second long preambles 305, channel responses between all the antennas of the wireless communication device 101 and all the antennas of the wireless communication device 102 can be estimated. Outputting the estimated channel responses to the transmitter (not shown) of the wireless communication device 101 allows the transmitter to transmit a signal to the wireless communication device 102 by using the E-SDM scheme, the W-SDM scheme, the adaptive modulation scheme, or the like. Since the E-SDM scheme, the W-SDM scheme, the adaptive modulation scheme, and the like are known techniques, a detailed description thereof will be omitted.

The wireless communication device then receives the data fields 306 transmitted from the antennas 208-1 to 208-3, and causes the digital demodulator 405 to perform demodulation processing for a signal in the frequency domain corresponding to each data field 306 by using the information of the number of data streams recognized from the packet length information in the signal field 303 and the result of estimated the channel response by using the second long preamble 305. For demodulation processing, a known technique such as a spatial filtering method or a maximum likelihood detection can be used.

As has been described above, according to this embodiment, wireless packet signals for channel response estimation which are transmitted from the wireless communication device 102 to the wireless communication device 101 are designed such that the respective subcarriers of data streams are interleaved for all the antennas 208-1 to 208-3. For this reason, the frame arrangement is so formed as to commonly transmit the preambles (second short preambles) 304 for AGC, channel estimation preambles (second long preambles) 305, and data fields 306 from the antennas 208-1 to 208-3. Therefore, by setting a gain for the variable gain amplifier 502 using the signal of the second short preamble 304 for AGC, the input levels of the signals of the second long preamble 305 for channel response estimation and the data field 306 to the analog-to-digital converter 503 are properly adjusted. This makes it possible to reduce the influences of saturation and quantization errors and improve the reception precision.

In addition, since the frame arrangement is so formed as to transmit the second long preambles for channel response estimation from all the antennas 208-1 to 208-3, the wireless communication device 101 can estimate channel responses between all the antennas of the wireless communication device 101 and all the antennas of the wireless communication device 102 by receiving wireless packet signals for channel response estimation. This makes it possible to communicate by using the E-SDM scheme, the W-SDM scheme, the adaptive modulation scheme, or the like.

In addition, since the subcarriers of respective data streams in the data fields 306 are distributed to the plurality of antennas 208-1 to 208-3, even if a signal to be transmitted from a given one of the antennas is not properly transmitted due to some problem on a propagation path, there is a low possibility that a given data stream will be entirely disrupted. This makes it possible to improve the reliability of communication.

According to the embodiment of the present invention, since AGC preambles, channel estimation preambles, and data fields are transmitted from all antennas when a wireless packet signal for channel response estimation is to be transmitted, the influences of saturation of the output of an analog-to-digital converter and quantization errors can be reduced by setting a gain by using the AGC preambles upon reception of the wireless packet signal for channel response estimation, thereby improving the reception precision. In addition, since channel estimation preambles are transmitted from a plurality of antennas, channel responses between all the transmission antennas and all the reception antennas can be estimated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication method comprising:
transmitting automatic gain control (AGC) preambles by using a plurality of antennas;
transmitting channel estimation preambles after transmission of the AGC preambles by using the plurality of antennas; and
transmitting at least one data stream as subcarriers distributed to the plurality of antennas after transmission of the AGC preambles by using the plurality of antennas.

2. A method according to claim 1, wherein the transmitting the data streams including transmitting the data stream as the subcarriers distributed to the plurality of antennas when number of the data streams is smaller than number of the antennas.

3. A method according to claim 1, wherein the transmitting the data streams including transmitting the data stream by using subcarriers at different positions for the respective data streams.

4. A wireless communication device comprising:
a plurality of antennas; and
a generating unit configured to generate a wireless packet signal comprising an automatic gain control (AGC) preamble to be transmitted by using the plurality of antennas, a channel estimation preamble to be transmitted after transmission of the AGC preamble by using the plurality of antennas, and at least one data stream to be transmitted by the plurality of antennas, as subcarriers distributed to the plurality of antennas after transmission of the channel estimation preamble.

5. A wireless communication device according to claim 4, wherein the generating unit comprises a preamble generating unit configured to generate the AGC preamble and the channel estimation preamble, and a subcarrier generating unit configured to generate the subcarriers.

6. A wireless communication device according to claim 4, wherein the generating unit is configured to generate the data streams transmitted as subcarriers distributed to the plurality of antennas when number of the data streams is smaller than number of the antennas.

7. A wireless communication device according to claim 4, wherein the generating unit is configured to generate the data streams transmitted by using subcarriers at different positions for the respective data streams.

8. A wireless communication device comprising:
a receiver which generates a reception signal by receiving a plurality of automatic gain control (AGC) preambles to be transmitted from a plurality of antennas, a channel estimation preamble to be transmitted after transmission of the AGC preambles from the plurality of antennas, and at least one data stream to be transmitted by the plurality of antennas, as subcarriers distributed to the plurality of antennas after transmission of the channel estimation preamble;
a variable gain amplifier which amplifies the reception signal;
a gain control unit configured to controls a gain of the variable gain amplifier by using information of the AGC preamble contained in the reception signal; and
an analog-to-digital converter which converts an output signal from the variable gain amplifier into a digital signal.

9. A device according to claim 8, further comprising:
an estimation unit configured to estimate a channel response by using information of the channel estimation preamble contained in the digital signal; and
a demodulator which demodulates the digital signal in accordance with the estimated channel response.

10. A device according to claim 8, further comprising:
an estimation unit configured to estimate a channel response by using information of the channel estimation preamble contained in the digital signal; and
a transmitter which transmits a transmission signal in accordance with the estimated channel response.

11. A device according to claim 8, further comprising:
an estimation unit configured to estimate a channel response by using information of the channel estimation preamble contained in the digital signal;
a demodulator which demodulates the digital signal in accordance with the estimated channel response; and
a transmitter which transmits a data transmission signal in accordance with the estimated channel response.

12. A device according to claim 8, wherein the receiver is configured to receive the data streams transmitted as the subcarriers distributed to the plurality of antennas when number of the data streams is smaller than number of the antennas.

13. A device according to claim 8, wherein the receiver is configured to receive the data streams transmitted by using the subcarriers at different positions for the respective data streams.

14. A wireless communication method comprising:
transmitting a request signal to a second wireless communication device with a first wireless communication device;
transmitting a wireless packet signal in response to the request signal with the second wireless communication device via a plurality of antennas, the wireless packet signal comprising an automatic gain control (AGC) preamble, a channel estimation preamble, and at least one data stream as subcarriers distributed to the plurality of antennas; and
estimating a channel response by receiving the wireless packet signal with the first wireless communication device.

15. A wireless communication method according to claim 14, wherein transmitting the wireless packet signal includes transmitting the data streams as subcarriers distributed to the plurality of antennas when number of the data streams is smaller than number of the antennas.

16. A wireless communication method according to claim 14, wherein transmitting the wireless packet signal includes transmitting the data streams by using subcarriers at different positions for the respective data streams.
